(19) United States
(12) Patent Application Publication
(10) Pub. No.: US 2002/0011935 A1
(43) Pub. Date: Jan. 31, 2002

(54) Electric system with electricity leakage prevention and warning system for hybrid electric vehicle and method for controlling same

(76) Inventor: Young-Rock Kim, Kyungki-do (KR)

Correspondence Address: BIRCH STEWART KOLASCH & BIRCH, PO BOX 747, FALLS CHURCH, VA, 22040-0747, US

(21) Appl. No.: 09/838,325

(22) Filed: Apr. 20, 2001

(30) Foreign Application Priority Data
May 12, 2000 (KR) 2000-25353

(51) Int. Cl. B60Q 1/00

(52) U.S. Cl. 340/635; 340/636; 324/509

(57) ABSTRACT

An electric system with an electricity leakage prevention and warning system for a hybrid electric vehicle includes batteries connected in series through battery cables, which are connected to battery connectors of the batteries; a current malfunction detection terminal connected to the battery cables between the batteries, and which detects a current malfunction; a battery contact terminal switch performing a switching operation according to an operation of the current malfunction detection terminal; an electronic control unit detecting an on operation of the battery contact terminal switch and detecting a charge level of the batteries; and a transformer fuse automatic cut-off unit for detecting the on operation of the battery contact terminal switch, and automatically cutting off a fuse of a transformer using an electric signal.

### BACKGROUND OF THE INVENTION

(a) Field of the Invention

The present invention relates to an electric system for a hybrid electric vehicle and a method for controlling the same. More particularly, the present invention relates to an electricity leakage prevention and warning system for a hybrid electric vehicle and a method for controlling the same in which a current malfunction, occurring as a result of the severing or removal of a battery cable from a battery is detected, then a transformer fuse is cut-off automatically and the driver is alerted of the malfunction.

Hybrid electric vehicles (HEVS) combine the internal combustion engine of a conventional vehicle with the battery and electric motor of an electric vehicle, resulting in twice the fuel economy of conventional vehicles. This combination offers the extended range and rapid refueling that consumers expect from a conventional vehicle, with a significant portion of the energy and environmental benefits of an electric vehicle. The practical benefits of HEVs include improved fuel economy and lower emissions compared to conventional vehicles. The inherent flexibility of HEVs will allow them to be used in a wide range of applications, from personal transportation to commercial hauling.

(b) Description of the Related Art

Hybrid electric vehicles (HEVs) combine the internal combustion engine of a conventional vehicle with the battery and electric motor of an electric vehicle. In an HEV, a current generated by the operation of the engine and generator charges a battery unit and is supplied to a drive motor, which uses this energy to propel the drive wheels. The battery unit typically includes three batteries connected in parallel to generate a total voltage of 440V, which is also used to power the drive motor.

Because of the engine and electric motor combination, the vehicle can still be operated if the battery unit malfunctions. That is, if battery cables connecting the batteries of the battery unit become damaged, power is transmitted to a traction motor from an auxiliary power device, which is comprised of the motor and generator. Hence, the main power source for the operation of the vehicle is the traction motor, and the batteries are charged by excess power and act to supply power to the drive traction motor when needed.

If a battery cable becomes removed or is severed, a very dangerous situation results in which passengers or others coming into contact with metal parts of the vehicle may receive an electric shock. In extreme cases, persons may be electrocuted.

### SUMMARY OF THE INVENTION

The present invention has been made in an effort to solve the above problems.

It is an object of the present invention to provide an electric system with an electricity leakage prevention and warning system for a hybrid electric vehicle and a method for controlling the same in which a current malfunction occurring as a result of the severing or removal of a battery cable from a battery is detected, then a transformer fuse is cut-off automatically and the driver is alerted of the malfunction.

To achieve the above object, the present invention provides an electric system with an electricity leakage prevention and warning system for a hybrid electric vehicle and a method for controlling the same. The electric system comprises first, second and third batteries connected in series through battery cables, which are connected to battery connectors of the batteries; a current malfunction detection terminal connected to the battery cables between the batteries, the current malfunction detection terminal detecting a current malfunction; a battery contact terminal switch performing a switching operation according to an operation of the current malfunction detection terminal; an electronic control unit detecting an on operation of the battery contact terminal switch and detecting a charge level of the first, second and third batteries; and a transformer fuse automatic cut-off unit for detecting the on operation of the battery contact terminal switch, and automatically cutting off a fuse of a transformer using an electric signal.

According to a feature of the present invention, the electricity leakage prevention and warning system for a hybrid electric vehicle further comprises an instrument panel buzzer for receiving signals from the electronic control unit, and if there is a battery malfunction, performing control to alert the driver of the malfunction.

The method for controlling an electricity leakage prevention and warning system for a hybrid electric vehicle comprises the steps of (a) detecting, by a current malfunction detection terminal, a malfunction of battery cables such as a short circuit in the removal of the battery cable from a battery; (b) determining if a battery contact terminal switch is switched to on, which occurs as a result of an operation of the current malfunction detection terminal; (c) automatically cutting off a fuse of a transformer by an electric signal output by a transformer fuse automatic cut-off unit if the battery contact terminal switch switches to on, and repeating step (b) if the battery contact terminal does not switch to on; and (e) applying an electric signal to an instrument panel buzzer such that the instrument panel performs control to alert the driver of a battery malfunction if the battery contact terminal switch is switched to on in step (b).

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a block diagram of an electricity leakage prevention system for a hybrid electric vehicle and elements in the vehicle to which the system is applied according to a preferred embodiment of the present invention; and

FIG. 2 is a flow chart of a method for controlling an electricity leakage prevention system for a hybrid electric vehicle according to a preferred embodiment of the present invention.

### DETAILED DESCRIPTION OF THE PREFERRED EMBODIMENTS

Preferred embodiments of the present invention will now be described in detail with reference to the accompanying drawings.

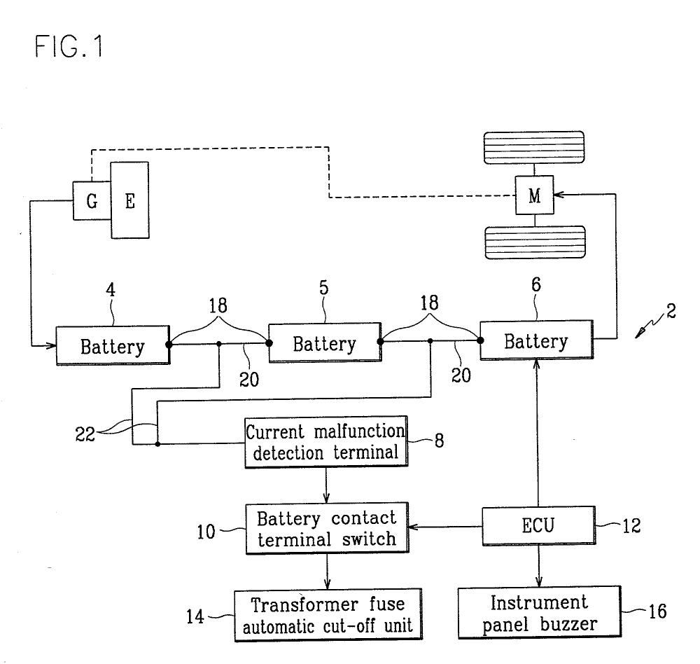

FIG. 1 shows an electric-related diagram of a hybrid electric vehicle to which an electricity leakage prevention system is applied according to a preferred embodiment of the present invention.

As shown in the drawing, an electric-related system of a hybrid electric vehicle including an electricity leakage prevention system comprises first, second and third batteries 4, 5 and 6; a current malfunction detection terminal 8; a battery contact terminal switch 10; an electronic control unit 12; a transformer fuse automatic cut-off unit 14; and an instrument panel buzzer 16.

The first, second and third batteries 4, 5 and 6 are connected in series. That is, battery cables 20 connect battery connectors 18 of the batteries 4, 5 and 6. The batteries 4, 5 and 6 supply a voltage of, for example, 440V. The current malfunction detection terminal 8 is connected to the battery cables 20 through wires 22, and detects malfunctions such as a short circuit in or the removal of a battery cable 20 from a battery.

In the hybrid electric vehicle, in the case where there is damage to the battery cables 20, current is nevertheless supplied to a traction motor M, which is the main drive source, by an auxiliary drive system made up of an engine E and a generator G. Here, the batteries 4, 5 and 6 are charged by excess current and supply power to the traction motor M when needed.

The battery contact terminal switch 10 detects the operation of the current malfunction detection terminal 8 by an electric signal, and switches to on. The electronic control unit 12 detects the on operation of the battery contact terminal switch 10, and also detects a charge level of the first, second and third batteries 4, 5 and 6.

The transformer fuse automatic cut-off unit 14 automatically cuts off a fuse of a transformer by an electric signal when the battery contact terminal switch 10 switches to on. The instrument panel buzzer 16 receives signals from the electronic control unit 12, and if the signals indicate that there is a battery malfunction, performs control to alert the driver of the malfunction. The instrument panel buzzer 16 is connected to an instrument panel of the vehicle.

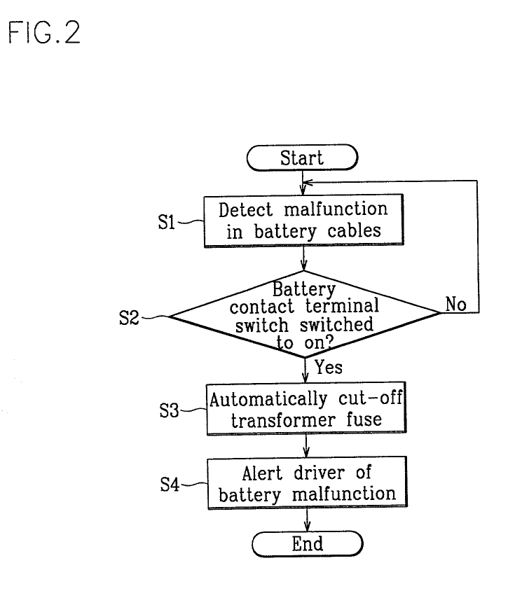

FIG. 2 shows a flow chart of a method for controlling an electricity leakage prevention system for a hybrid electric vehicle according to a preferred embodiment of the present invention.

First, the current malfunction detection terminal 8 detects a malfunction in the battery cables 20 such as a short circuit in or the removal of the battery cable 20 from a battery in step S1. Next, it is determined if the battery contact terminal switch 10 is switched to on in step S2. That is, the battery contact terminal switch 10 detects the operation of the current malfunction detection terminal 8 by an electric signal and switches to on, after which the on operation of the battery contact terminal switch 10 is detected by the electronic control unit 12 and the transformer fuse automatic cut-off unit 14.

Subsequently, if the battery contact terminal switch 10 switches to on in step S2, the transformer fuse automatic cut-off unit 14 automatically cuts off a fuse of the transformer by an electric signal such that the flow of current is discontinued in step S3. When the electronic control unit 12 detects the on operation of the battery contact terminal switch 10 in step S2, the electronic control unit 12 applies an electric signal to the instrument panel buzzer 16 such that the instrument panel buzzer 16 performs control to alert the driver of a battery malfunction in step S4.

In the electricity leakage prevention and warning system for a hybrid electric vehicle and a method for controlling the same of the present invention, a current malfunction occurring as a result of the severing or removal of a battery cable from a battery is detected, then the fuse of the transformer is cutoff automatically and the driver is alerted to the malfunction. Accordingly, the risk of electric shock and electrocution to passengers or others coming into contact with metal parts of the vehicle is prevented.

Although preferred embodiments of the present invention have been described in detail hereinabove, it should be clearly understood that many variations and/or modifications of the basic inventive concepts herein taught which may appear to those skilled in the present art will still fall within the spirit and scope of the present invention, as defined in the appended claims.

What is claimed is:

1. An electric system with an electricity leakage prevention and warning system for a hybrid electric vehicle comprising:
a plurality of batteries connected in series through battery cables;
a current malfunction detection terminal connected to the battery cables between the batteries, the current malfunction detection terminal detecting a current malfunction;
a battery contact terminal switch performing a switching operation according to an operation of the current malfunction detection terminal;
an electronic control unit detecting an on operation of the battery contact terminal switch and detecting a charge level of the batteries; and
a transformer fuse automatic cut-off unit for detecting the on operation of the battery contact terminal switch, and automatically cutting off a fuse of a transformer using an electric signal.

2. The electric system of claim 1 further comprising an instrument panel buzzer for receiving signals from the electronic control unit, and if there is a battery malfunction, performing control to alert the driver of the malfunction.

3. A method for controlling an electricity leakage prevention and warning system for a hybrid electric vehicle comprising the steps of:
(a) detecting, by a current malfunction detection terminal, a malfunction of battery cables such as a short circuit in or the removal of a battery cable from a battery;
(b) determining if a battery contact terminal switch is switched to on, which occurs as a result of an operation of the current malfunction detection terminal; and
(c) automatically cutting off a fuse of a transformer by an electric signal output by a transformer fuse automatic cut-off unit if the battery contact terminal switch switches to on, and repeating step (b) if the battery contact terminal does not switch to on; and

4. A method for controlling an electricity leakage prevention warning system of claim 3 further comprising the step of applying an electric signal to an instrument panel buzzer such that the instrument panel performs control to alert the driver of a battery malfunction if the battery contact terminal switch is switched to on in step (b).
